(19) United States
(12) Patent Application Publication
(10) Pub. No.: US 2026/0214005 A1
(43) Pub. Date: Jul. 23, 2026

(54) CONFIG-LESS MIRROR FEATURE PROVISIONING IN WIRELESS COMMUNICATION NETWORKS

(71) Applicant: T-Mobile USA, Inc., Bellevue, WA (US)

(72) Inventor: Mullaiarasu Sundaramurthy, Maple Valley, WA (US)

(21) Appl. No.: 19/035,543

(22) Filed: Jan. 23, 2025

(51) Int. Cl. H04L 41/0866; H04L 41/084

(52) U.S. Cl. CPC H04L 41/0866; H04L 41/084

(57) ABSTRACT

Techniques and architecture described herein provide a method for simplifying configuration changes for mirror features in a provisioning engine. By including both an original feature code and a mirror feature code in the request and implementing a one-time update to a provisioning engine, the system can provision the same configurations for both features, eliminating the need for manual updates to a provisioning catalog.

### BACKGROUND

Service providers often provide services via a network, e.g., a wireless communication network operator, a media services provider (which may provide the services via a wireless communication network, a wired communication network, or a combination of the two), etc. In the field of network provisioning within a network, systems such as a network provisioning engine (NPE) play a crucial role. The NPE is a unified system that abstracts network complexity, provides a common feature fulfillment configuration, and reduces the lead time to market. The NPE utilizes a catalog, known as the network provisioning catalog (NPC), to map features from northbound systems to the configuration changes required in southbound network (e.g., engineering) elements or nodes.

The NPC serves as the database that the NPE uses to map features (e.g., services provided, prices, service plans, price plans, etc.) to their corresponding configuration parameters for impacted southbound network elements when the NPC receives calls from northbound systems. As an example, in wireless communication networks, these network elements include, but are not limited to, a provisioning gateway (PGW), a short message service center (SMSC), an application publisher (AP), a voice mail register (VMR), an (opportunistic mesh (OPM), a caller tuners server, etc.

In catalog-driven provisioning solutions, the catalog (e.g., the NPC) must be updated to configure new services, update existing ones, and remove outdated ones. The existing catalog configuration process is manual and accomplished utilizing, for example, an ECM Catalog Designer tool. However, this process is time-consuming and requires significant expertise. Catalog custom-built rules translate user requirements (features) into a set of parameters that may be understood by network elements, governing the user experience. Currently, the introduction of new mirror features necessitates manual updates to the NPC to include these new features. This process is labor-intensive and error-prone, leading to inefficiencies in network management. However, these new mirror features are often the same as previous features but with different names.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 schematically illustrates an example block diagram of an architecture for a portion of a wireless communication network that provisions a new feature code that is a mirror or duplicate of a previous feature code, according to some implementations.

FIG. 2 illustrates an example flow for an example of provisioning a new feature code that is a mirror or duplicate of a previous feature code, according to some implementations.

FIG. 3 is a flow diagram illustrating an example method for provisioning a new feature code that is a mirror or duplicate of a previous feature code, according to some implementations.

FIG. 4 schematically illustrates a component level view of a server configured for use with the techniques and architecture described herein, according to some implementations.

### DETAILED DESCRIPTION

Described herein are techniques and architecture that simplify the configuration changes required for implementing mirror features in a network, e.g., in a network provisioning engine (NPE) of a wireless communication network. More particularly, the techniques and architecture described herein simplify the configuration changes required for implementing mirror features in a network, e.g., in a NPE of a wireless communication network by following a “catalog-driven” pattern, and through the implementation of a network provisioning catalog, abstracting various layers of entities involved in the provisioning and charging chain. Each layer contains a consistent set of entities, modeled according to the functional scope the entities are expected to supply.

More particularly, the techniques and architecture strive to eliminate the need for manual updates to a network provisioning catalog (NPC) for new mirror or duplicate features. By modifying a request for provisioning a second feature to include both an original feature and a mirror feature, and by implementing a one-time update to an NPE customer adaptation layer (also referred to as NPE service model) to recognize that both the mirror and original feature codes are mirrors, the system can provision the same set of configurations for both feature codes. This streamlines the provisioning process, reduces manual intervention, and enhances overall system efficiency.

For example, as is known, within a network that includes an NPE (or similar functionality), with the conventional network provisioning process, the NPE receives feature codes from a northbound system. For each new mirror feature, a manual update to the NPC is required to map the feature to the necessary configuration changes in southbound network elements such as, for example, a provisioning gateway (PGW), a short message service center (SMSC), an application publisher (AP), a voice mail register (VMR), an (opportunistic mesh (OPM), a caller tuners server, etc. (within an example wireless communication network).

In contrast, in accordance with the techniques and architecture described herein, the NPE receives a request that includes both the original feature code in the dynamic parameter info of the feature and the mirror feature code. A one-time update to the NPE customer adaptation layer allows the system to recognize that the mirror feature code and the original feature code are mirrors of each other, (e.g., corresponds to a same feature or feature plan). Consequently, the NPE provisions the same set of configurations for both codes, eliminating the need for manual catalog updates.

More particularly, in accordance with the techniques and architecture described herein, within a wireless communication network (for example), a request is received from a northbound system, e.g., a business support system (BSS), including both an original feature code (corresponding to an original feature or an original feature plan comprising multiple features) as dynamic parameter info of the feature and a mirror feature code (corresponding to a mirror feature or a mirror feature plan comprising multiple mirror features). In configurations, the request may include multiple mirror feature codes corresponding to multiple mirror or duplicate features or multiple mirror or duplicate feature plans. The request is received successfully by the NPE and is valid to southbound network elements. The NPE customer adaptation layer then schedules the request for provisioning.

The NPE customer adaptation layer identifies that the mirror feature code is a mirror of (e.g., corresponds to a same feature or feature plan) the original feature code. The NPE performs a look up for the feature information from the NPC. The NPC returns the configuration parameters defined in the NPC corresponding to the original feature code. These configuration parameters for the original feature code are then provisioned for the mirror feature code to the respective southbound network elements such as, for example, the PGW, the SMSC, the NAP, the VMR, the OPM, Caller Tuners Server, etc.

For example, a northbound system sends a request to provision a new mirror feature WPSDL1 that duplicates the configurations of an existing original feature WPS1.The request includes both WPS1 and WPSDL1 as a mirror of WPS1. The NPE customer adaptation layer identifies the equivalence and provisions the configurations for WPS1 to WPSDL1 without the need for updating the mirror feature code in the NPC.

In configurations, a sample feature request may look like below after the change implementation.

```
″featureInfo″: {
  ″featureAdd″: [
    {
      ″feature″: “WPSDL1“
      ″dynamicFeatureParameterInfo″: [
        {
          ″paramName″: “mirror″,
          “paramValue″: “WPS1″
        }
      }
    ]
  }
```

Accordingly, as an example, a method comprises providing, within a computing network, a feature provided by a service provider, wherein the feature is identified by a first feature code. The method also comprises receiving, by a provisioning engine of the computing network, a request for provisioning a second feature code that is directed to the feature provided by the service provider, wherein the second feature code mirrors the first feature code, and wherein the request comprises the first feature code and the second feature code. The method further comprises identifying, by the provisioning engine, that the second feature code is a mirror of the first feature code. The method additionally comprises based at least in part on the first feature code, obtaining, by the provisioning engine from a provisioning catalog, configuration parameters for the feature in response to the second feature code being identified as a mirror of the first feature code. The method also comprises provisioning, by the provisioning engine, the configuration parameters for the second feature code to one or more network elements that implement the feature provided by the service provider.

In configurations, the service provider comprises a wireless communication network.

In some configurations, the one or more network elements comprise one or more of at least one of a provisioning gateway (PGW), a short message service center (SMSC), an application publisher (AP), a voice mail register (VMR), an opportunistic mesh (OPM), or a caller tuners server.

In configurations, the request comprises a third feature code directed to the feature provided by the service provider, wherein the third feature code mirrors the feature code. In such configurations, the method further comprises identifying, by the provisioning engine, that the third feature code is a mirror of the first feature code and provisioning, by the provisioning engine, the configuration parameters for the third feature code to one or more network elements that implement the feature provided by the service provider.

In configurations, the service provider comprises a media content provider.

In some configurations, the media content provider provides one or more of television, movies, music, or gaming.

As another example, a system comprises one or more processors; and one or more non-transitory computer-readable media storing computer-executable instructions that, when executed by the one or more processors, cause the one or more processors to perform actions. In configurations, the actions comprise providing, within a computing network, a feature provided by a service provider, wherein the feature is identified by a first feature code. The actions also comprise receiving, by a provisioning engine of the computing network, a request for provisioning a second feature code that is directed to the first feature provided by the service provider, wherein the second feature code mirrors the first feature code, and wherein the request comprises the first feature code and the second feature code. The actions further comprise identifying, by the provisioning engine, that the second feature code is a mirror of the first feature code. The actions additionally comprise based at least in part on the first feature code, obtaining, by the provisioning engine from a provisioning catalog, configuration parameters for the first feature in response to the second feature code being identified as a mirror of the first feature code. The actions also comprise provisioning, by the provisioning engine, the configuration parameters for the second feature code to one or more network elements that implement the feature provided by the service provider.

Thus, the techniques and architecture described herein strive to eliminate the need for manual updates to a network provisioning catalog (NPC) for new mirror or duplicate features. By modifying a request for provisioning a second feature to include both an original feature code and the mirror feature code, and by implementing a one-time update to an NPE customer adaptation layer to recognize that both the mirror and original feature codes are identical, the system can provision the same set of configurations for both feature codes. This streamlines the provisioning process, reduces manual intervention, and enhances overall system efficiency.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

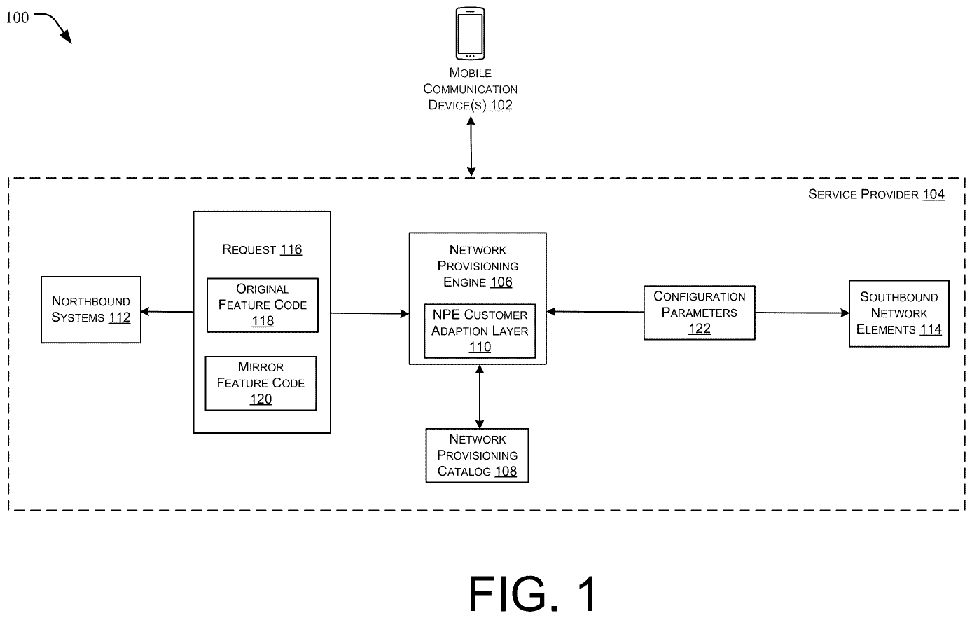

FIG. 1 schematically illustrates an example portion of a wireless communication network 100. Those skilled in the art will understand that a wired communication network (not illustrated) may be used in place of or in conjunction with the wireless communication network 100 when implementing the techniques and architecture described herein. Mobile communication device(s) 102, e.g., a smart phone, a television, a smart appliance (e.g., an Internet of Things (IoT) device), a laptop, a tablet, a personal computer, etc., are configured to operate within the wireless communication network 100.

In configurations, mobile communication device(s) 102 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the mobile communication device(s) 102 as being “mobile” (i.e., configured to be carried and moved around), it is to be appreciated that the mobile communication device(s) 102 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile communication device,” “mobile device,” “computing device,” “portable electronic device,” and “user equipment (UE)” may be used interchangeably herein to describe any communication device capable of performing the techniques described herein.

The mobile communication device(s) 102 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), 4G Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), 5G, IEEE 802.1x protocols, WiMAX, Wi-Fi, and/or any future IP-based network technology or evolution of an existing IP-based network technology.

FIG. 1 also schematically illustrates a service provider 104 that provides services via the wireless communication network 100 and/or a wired communication network (not illustrated). For example, in configurations, the service provider 104 may be an operator of the wireless communication network 100. In configurations, the service provider may be, for example, a media content provider that provides, for example, one or more of television, movies, music, or gaming, etc. As is known, there are other types of service providers that provide services via wireless communication networks and/or wired communication networks and the examples provided herein are not meant to be limiting.

FIG. 1 further schematically illustrates a provisioning engine and a provisioning catalog, which in the present example is in the form of a network provisioning engine (NPE) 106 that is in communication with a network provisioning catalog (NPC) 108. In configurations, the NPC 108 may be part of the NPE 106, e.g., one or more servers may be used to implement both the NPE 106 and the NPC 108. The NPE 106 includes an NPE customer adaptation layer (also referred to as NPE service model) 110. The service provider 104 further includes northbound systems 112 and southbound network elements 114.

In configurations, a first (original) feature or feature plan is provided and stored in the NPC 108. A request 116 for provisioning a second (mirror or duplicate) feature or feature plan is received from a northbound system 112, e.g., a business support system (BSS). The second feature or feature plan includes the same feature or feature plan as the first (original) feature or feature plan. The request 116 includes both an original feature code 118, corresponding to the first (original) feature or feature plan and a mirror feature code 120, corresponding to the second (mirror) feature or feature plan. Examples of features include, but are not limited to, services provided, prices, service plans, price plans, etc. Generally, the primary difference between the duplicate feature plan and the original feature plan are their feature plan names and the feature codes (which are defined as mirrors of each other though). The features included are the same in the mirror feature plan and the original feature plan.

The request 116 includes both the original feature code 118 as dynamic parameter info of the feature and the mirror feature code 120. In configurations, the request 116 may include multiple mirror feature codes 120 corresponding to multiple mirror or duplicate feature plans. The request 116 is received successfully by the NPE 106 and verified as valid to southbound network elements 114. The NPE customer adaptation layer 110 then schedules the request 116 for provisioning.

The NPE customer adaptation layer 110 identifies that the mirror feature code 120 is a mirror of the original feature code 118. The NPE 106 performs a look-up for the feature information from the NPC 108. The NPC 108 returns the configuration parameters 122 corresponding to the original feature plan defined in the NPC 108. These configuration parameters 122 are then provisioned for the mirror feature plan (or plans) to the respective southbound network elements 114 such as, for example, a provisioning gateway (PGW), a short message service center (SMSC), an application publisher (AP), a voice mail register (VMR), an opportunistic mesh (OPM), or a caller tuners server, etc.

For example, a northbound system 112 sends a request to provision a new mirror feature WPSDL1 that duplicates the configurations of an existing original feature WPS1. The request includes both WPS1 and WPSDL1. The NPE customer adaptation layer 110 identifies the equivalence and the NPC 108 provides the configuration parameters for WPS1 defined in the NPC 108. The NPE 106 maps the configuration parameters and provisions the configurations for WPS1 to WPSDL1 without the need for updating the mirror feature code in the NPC 108.

In configurations, a sample feature request may look like below after the change implementation.

```
″featureInfo″: {
  ″featureAdd″: [
    {
      ″feature″: “WPSDL1“
      ″dynamicFeatureParameterInfo″: [
        {
          ″paramName″: “mirror″,
          ″paramValue″: “WPS1″
        }
      }
    ]
  }
```

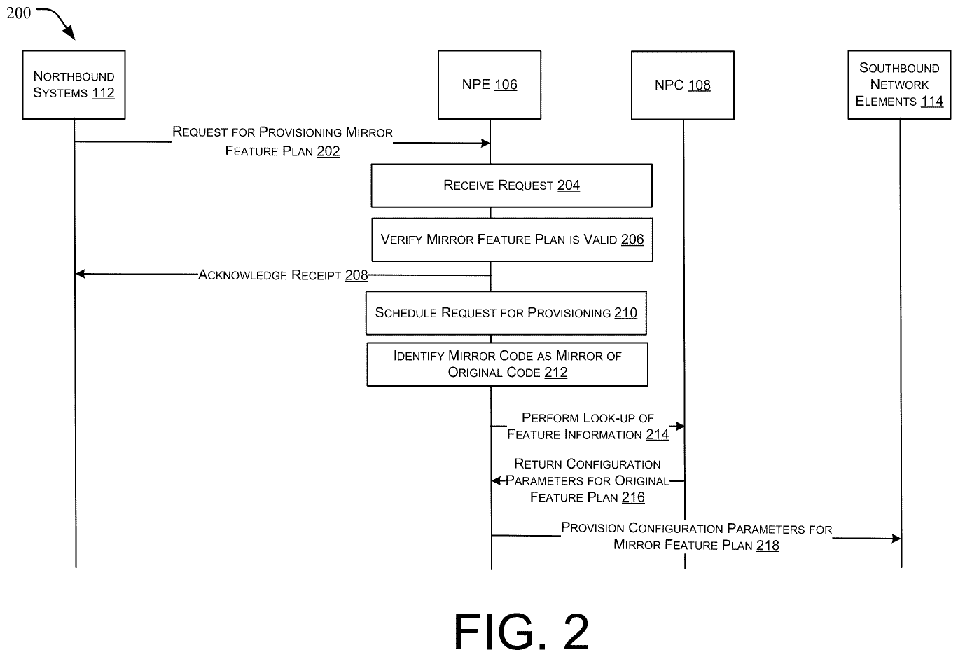

FIG. 2 illustrates an example flow 200 for an example of provisioning a new feature code that is a mirror or duplicate of a previous feature code. At 202, a request for provisioning a mirror (first or duplicate) feature plan comprising both an original feature (from a first (original) feature plan) and a duplicate (mirror) feature is received from a northbound system 112, e.g., a business support system (BSS). Examples of features include, but are not limited to, services provided, prices, service plans, price plans, etc. Generally, the primary difference between the mirror feature plan and the original feature plan are their feature plan names and codes. The features included are the same in the mirror feature plan and the original feature plan. The request includes both the original feature code 118 as dynamic parameter info of the feature and a mirror feature code 120.

At 204, the request is received successfully by the NPE 106. At 206, the NPE 106 verifies at least the mirror feature plan as valid to southbound network elements 114. At 208, in configurations, the NPE 106 acknowledges receipt of the request in response to the mirror feature plan being verified as being valid. At 210, the NPE 106 (via the NPE customer adaptation layer 110) then schedules the request for provisioning.

At 212, the NPE 106 (via the NPE customer adaptation layer 110) identifies that the mirror feature code 120 is a mirror of the original feature code 118. At 214, the NPE 106 performs a look-up for the feature information from the NPC 108 in response to the mirror feature code 120 being identified as a mirror of the original feature code 118. At 216, the NPC 108, returns, to the NPE 106, the configuration parameters 122 corresponding to the original feature plan defined in the NPC 108 for the mirror feature plan. At 218, these configuration parameters 122 are then provisioned by the NPE 106 for the mirror feature plan to the respective southbound network elements 114 such as, for example, a provisioning gateway (PGW), a short message service center (SMSC), an application publisher (AP), a voice mail register (VMR), an opportunistic mesh (OPM), or a caller tuners server, etc.

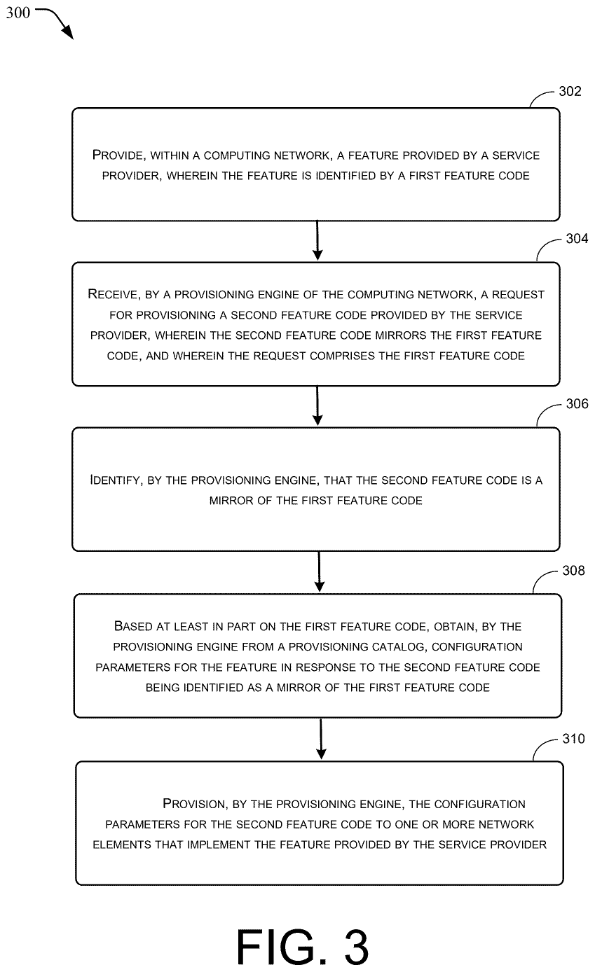

FIG. 3 is a flow diagram illustrating an example method for provisioning a new feature code that is a mirror or duplicate of a previous feature code. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

At 302, within a computing network, a first feature is provided that is provided by a service provider, wherein the first feature is identified by a first feature code. At 304, a provisioning engine of the computing network receives a request for provisioning a second feature code that is directed to the feature provided by the service provider, wherein the second feature code mirrors the first feature code, and wherein the request comprises the first feature code and the second feature code. For example, in configurations, a first (original) feature or feature plan is provided and stored in the NPC 108. A request 116 for provisioning a second (mirror or duplicate) feature or feature plan is received from a northbound system 112, e.g., a business support system (BSS). The second feature or feature plan includes the same feature or feature plan as the first (original) feature or feature plan. The request 116 includes both an original feature code 118, corresponding to the first (original) feature or feature plan and a mirror feature code 120, corresponding to the second (mirror) feature or feature plan. Examples of features include, but are not limited to, services provided, prices, service plans, price plans, etc. Generally, the primary difference between the duplicate feature plan and the original feature plan are their feature plan names and the feature codes (which are defined as mirrors of each other though). The features included are the same in the mirror feature plan and the original feature plan.

The request 116 includes both the original feature code 118 as dynamic parameter info of the feature and the mirror feature code 120. In configurations, the request 116 may include multiple mirror feature codes 120 corresponding to multiple mirror or duplicate feature plans. The request 116 is received successfully by the NPE 106 and verified as valid to southbound network elements 114. The NPE customer adaptation layer 110 then schedules the request 116 for provisioning.

At 306, identifying, by the provisioning engine, that the second feature code is a mirror of the first feature code. For example, the NPE customer adaptation layer 110 identifies that the mirror feature code 120 is a mirror of the original feature code 118.

At 308, based at least in part on the first feature code, obtaining, by the provisioning engine from a provisioning catalog, configuration parameters for the first feature plan in response to the second feature code being identified as a mirror of the first feature code. For example, the NPE 106 performs a look-up for the feature information from the NPC 108. The NPC 108 returns the configuration parameters 122 corresponding to the original feature plan defined in the NPC 108.

At 310, the provisioning engine provisions the configuration parameters for the second feature plan to one or more network elements that implement the one or more features provided by the service provider. For example, the configuration parameters 122 are then provisioned for the mirror feature plan (or plans) to the respective southbound network elements 114 such as, for example, a provisioning gateway (PGW), a short message service center (SMSC), an application publisher (AP), a voice mail register (VMR), an opportunistic mesh (OPM), or a caller tuners server, etc.

Thus, the techniques and architecture described herein strive to eliminate the need for manual updates to a network provisioning catalog (NPC) for new mirror or duplicate features. By modifying a request for provisioning a second feature to include both an original feature and the mirror feature, and by implementing a one-time update to an NPE customer adaptation layer to recognize that both the mirror and original feature codes are identical, the system can provision the same set of configurations for both feature codes. This streamlines the provisioning process, reduces manual intervention, and enhances overall system efficiency.

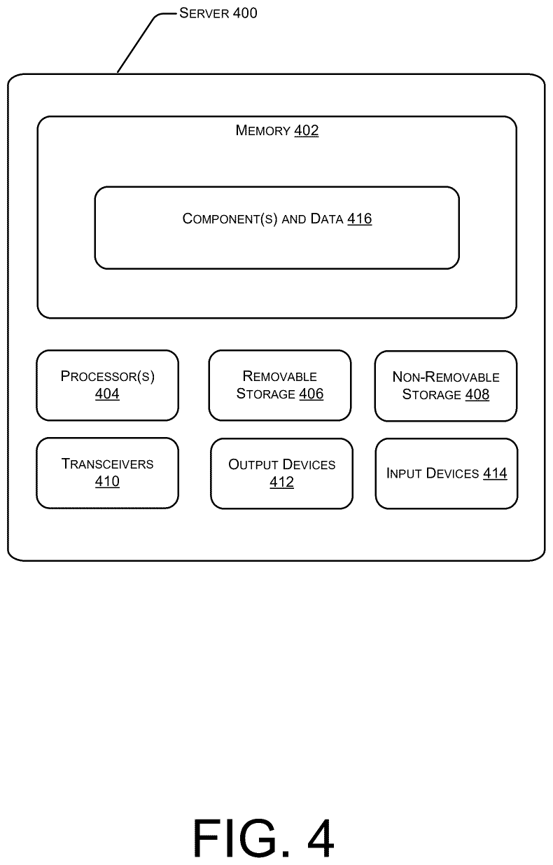

FIG. 4 schematically illustrates a component level view of a server 400 configured for use within a network, e.g., wireless communication network 100, in order to implement the techniques and architecture described herein, within the network. For example, one or more servers 400 may be configured to serve as the NPE 106 and/or the NPC 108. As another example, one or more servers 400 may be configured to serve as a northbound system 112. As a further example, one or more servers 400 may be configured to serve as one or more southbound network elements 114.

As illustrated, the server 400 comprises a system memory 402 that may store one or more components and/or applications and data 416 for interacting with mobile communication devices, e.g., mobile communication device 102, as described herein. Also, the server 400 may include processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.), or some combination of the two. In some implementations, the processor(s) 404 is a Central Processing Unit (CPU), a Graphics Processing Unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable storage 408 may include module(s) and data 416 (illustrated in the memory 402). The module(s) and data 416 may include instructions executable by, for example, the processor(s) 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also, or instead, the transceivers 410 may include wireless modem(s) to facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1 and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
providing, within a computing network, a feature provided by a service provider, wherein the feature is identified by a first feature code;
receiving, by a provisioning engine of the computing network, a request for provisioning a second feature code that is directed to the feature provided by the service provider, wherein the second feature code mirrors the first feature code, and wherein the request comprises the first feature code and the second feature code;
identifying, by the provisioning engine, that the second feature code is a mirror of the first feature code;
based at least in part on the first feature code, obtaining, by the provisioning engine from a provisioning catalog, configuration parameters for the feature in response to the second feature code being identified as a mirror of the first feature code; and
provisioning, by the provisioning engine, the configuration parameters for the second feature code to one or more network elements that implement the feature provided by the service provider.

2. The method of claim 1, wherein the service provider comprises a wireless communication network.

3. The method of claim 2, wherein the one or more network elements comprise one or more of at least one of a provisioning gateway (PGW), a short message service center (SMSC), an application publisher (AP), a voice mail register (VMR), opportunistic mesh (OPM), or a caller tuners server.

4. The method of claim 1, wherein the request comprises a third feature code directed to the feature provided by the service provider, wherein the third feature code mirrors the first feature code, and wherein the method further comprises:
identifying, by the provisioning engine, that the third feature code is a mirror of the first feature code; and
provisioning, by the provisioning engine, the configuration parameters for the third feature code to one or more network elements that implement the feature provided by the service provider.

5. The method of claim 4, wherein the service provider comprises a wireless communication network.

6. The method of claim 5, wherein the one or more network elements comprise one or more of at least one of a provisioning gateway (PGW), a short message service center (SMSC), an application publisher (AP), a voice mail register (VMR), opportunistic mesh (OPM), or a caller tuners server.

7. The method of claim 1, wherein the service provider comprises a media content provider.

8. The method of claim 7, wherein the media content provider provides one or more of television, movies, music, or gaming.

9. A system comprising:
one or more processors; and
one or more non-transitory computer-readable media storing computer-executable instructions that, when executed by the one or more processors, cause the one or more processors to perform actions comprising:
providing, within a computing network, a feature provided by a service provider, wherein the feature is identified by a first feature code;
receiving, by a provisioning engine of the computing network, a request for provisioning a second feature code that is directed to the feature provided by the service provider, wherein the second feature code mirrors the first feature code, and wherein the request comprises the first feature code and the second feature code;
identifying, by the provisioning engine, that the second feature code is a mirror of the first feature code;
based at least in part on the first feature code, obtaining, by the provisioning engine from a provisioning catalog, configuration parameters for the feature in response to the second feature code being identified as a mirror of the first feature code; and
provisioning, by the provisioning engine, the configuration parameters for the second feature code to one or more network elements that implement the feature provided by the service provider.

10. The system of claim 9, wherein the service provider comprises a wireless communication network.

11. The system of claim 10, wherein the one or more network elements comprise one or more of at least one of a provisioning gateway (PGW), a short message service center (SMSC), an application publisher (AP), a voice mail register (VMR), opportunistic mesh (OPM), or a caller tuners server.

12. The system of claim 9, wherein the request comprises a third feature code directed to the feature provided by the service provider, wherein the third feature code mirrors the first feature code, and wherein the actions further comprise:
identifying, by the provisioning engine, that the third feature code is a mirror of the first feature code; and
provisioning, by the provisioning engine, the configuration parameters for the third feature code to one or more network elements that implement the feature provided by the service provider.

13. The system of claim 12, wherein the service provider comprises a wireless communication network.

14. The system of claim 13, wherein the one or more network elements comprise one or more of at least one of a provisioning gateway (PGW), a short message service center (SMSC), an application publisher (AP), a voice mail register (VMR), opportunistic mesh (OPM), or a caller tuners server.

15. The system of claim 9, wherein the service provider comprises a media content provider.

16. The system of claim 15, wherein the media content provider provides one or more of television, movies, music, or gaming.

17. One or more non-transitory computer-readable media storing computer-executable instructions that, when executed by one or more processors, cause the one or more processors to perform actions comprising:
providing, within a computing network, a feature provided by a service provider, wherein the feature is identified by a first feature code;
receiving, by a provisioning engine of the computing network, a request for provisioning a second feature code that is directed to the feature provided by the service provider, wherein the second feature code mirrors the first feature code, and wherein the request comprises the first feature code and the second feature code;
identifying, by the provisioning engine, that the second feature code is a mirror of the first feature code;
based at least in part on the first feature code, obtaining, by the provisioning engine from a provisioning catalog, configuration parameters for the feature in response to the second feature code being identified as a mirror of the first feature code; and
provisioning, by the provisioning engine, the configuration parameters for the second feature code to one or more network elements that implement the feature provided by the service provider.

18. The one or more non-transitory computer-readable media of claim 17, wherein the service provider comprises a wireless communication network.

19. The one or more non-transitory computer-readable media of claim 18, wherein the one or more network elements comprise one or more of at least one of a provisioning gateway (PGW), a short message service center (SMSC), an application publisher (AP), a voice mail register (VMR), opportunistic mesh (OPM), or a caller tuners server.

20. The one or more non-transitory computer-readable media of claim 17, wherein the request comprises a third feature code directed to the feature provided by the service provider, wherein the third feature code mirrors the first feature code, and wherein the actions further comprise:
identifying, by the provisioning engine, that the third feature code is a mirror of the first feature code; and
provisioning, by the provisioning engine, the configuration parameters for the third feature code to one or more network elements that implement the feature provided by the service provider.
